(19) United States
(12) Patent Application Publication
(10) Pub. No.: US 2009/0302136 A1
(43) Pub. Date: Dec. 10, 2009

(54) INJECTOR

(75) Inventor: Jin Oh SONG, Anyang-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/337,261

(22) Filed: Dec. 17, 2008

(30) Foreign Application Priority Data
Jun. 5, 2008 (KR) 10-2008-0053356

(51) Int. Cl. B05B 1/02; F16K 27/00

(52) U.S. Cl. 239/584; 251/318; 251/368

(57) ABSTRACT

An injector may include an injector valve needle which is coated with a diamond-like carbon (DLC), and a valve seat that is selectively contacted with the injector valve needle and is coated with a modula tungsten carbide carbon (modula WCC).

### CROSS-REFERENCE TO RELATED APPLICATION

The present application claims priority to Korean Patent Application Number 10-2008-0053356 filed Jun. 5, 2008, the entire contents of which application is incorporated herein for all purposes by this reference.

### BACKGROUND OF THE INVENTION

1. Field of the Invention

The present invention relates to an injector. More particularly, the present invention relates to an injector including a coated valve needle and a coated valve seat for enhancing anti-corrosion and anti-abrasion characteristics.

2. Description of Related Art

In a conventional LPI fuel system, as shown in FIG. 4, a fuel temperature sensor 101 and a pressure sensor 103 detect states of fuel, information detected in the fuel temperature sensor 101 and the pressure sensor 103 is transferred to an electronic control apparatus (ECU), and the ECU controls an injector 105 to supply fuel at a suitable time. A fuel pump 107 is operated by the ECU for supplying fuel.

If the fuel pressure in an engine compartment is higher than a predetermined pressure that is regulated by a pressure regulator 109, surplus fuel returns to a fuel tank 111 by opening a diaphragm in the regulator 109.

When an LPI vehicle is stopped, a cut-off valve 113 disposed between the fuel tank 111 and a fuel line is closed, and the injector 105 is also closed.

At this point, the temperature of the engine compartment increases for a period of time, and the fuel temperature and the fuel pressure consequently increase. The fuel pressure subsequently decreases as a temperature equilibrium is reached.

In this case, sulfur (S) in LPG may react with oxygen (O2) to form sulfur dioxide (SO2) or sulfur trioxide (SO3), the sulfur dioxide (SO2) may react with water (H2O) in LPG to form sulfuric acid (H2SO4), and a resultant sulfuric acid solution (H2SO4+H2O) may act as an electrolyte that causes corrosion.

When a vehicle is driving, the solution may induce rapid corrosion and abrasion with a rapid chemical reaction caused by an increased fuel temperature.

The corrosion and abrasion may cause a leakage of fuel, and the leakage of fuel may cause a difficulty in engine starting, engine malfunctions, and so on.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide for an injector including a coated valve needle and a coated valve seat for enhancing anti-corrosion and anti-abrasion characteristics.

In an aspect of the present invention, an injector may include an injector valve needle which is coated with a diamond-like carbon (DLC), and a valve seat that is selectively contacted with the injector valve needle and is coated with a modula tungsten carbide carbon (modula WCC).

Hardness of the modular tungsten carbide carbon may be changed by adjusting a bias voltage when the modular tungsten carbide carbon is coated.

The various bias voltages may be supplied to the modular WCC layer from a lower layer to an upper layer of the modular WCC layer when the modular tungsten carbide carbon is coated.

The injector valve needle may be surfaced by ion etching before the injector valve needle starts to be coated.

The valve seat may be surfaced by ion etching before the valve seat starts to be coated.

The valve seat may be further coated with a chrome and a chromium nitride (CrN), in sequential order of the chrome, the chromium nitride, and the modula tungsten carbide carbon from a surface of the valve seat.

The valve seat may be surfaced by ion etching before the valve seat starts to be coated.

Thickness of the chrome coating may be approximately 0.1 μm-approximately 0.5 μm.

Thickness of the chromium nitride coating may be approximately 0.2 μm-approximately 0.7 μm.

Thickness of the modula tungsten carbide carbon coating may be approximately 1.0 μm-approximately 2.0 μm.

The injector valve needle may be further coated with a chrome and a tungsten carbide carbon in sequential order of the chrome, the tungsten carbide carbon, and the diamond-like carbon from a surface of the valve needle.

The injector valve needle may be surfaced by ion etching before the injector valve needle starts to be coated.

Thickness of the chrome coating may be approximately 0.1 μm-approximately 0.5 μm.

Thickness of the tungsten carbide carbon coating may be approximately 0.2 μm-approximately 0.7 μm.

Thickness of the diamond-like carbon coating may be approximately 1.0 μm-approximately 2.0 μm.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a drawing showing an exemplary fuel injector according to the present invention.

FIG. 2 is a drawing a surface of an exemplary valve seat according to the present invention.

FIG. 3 is a drawing a surface of an exemplary injector valve needle according to the present invention.

FIG. 4 is a drawing showing a conventional fuel system of an LPI vehicle.

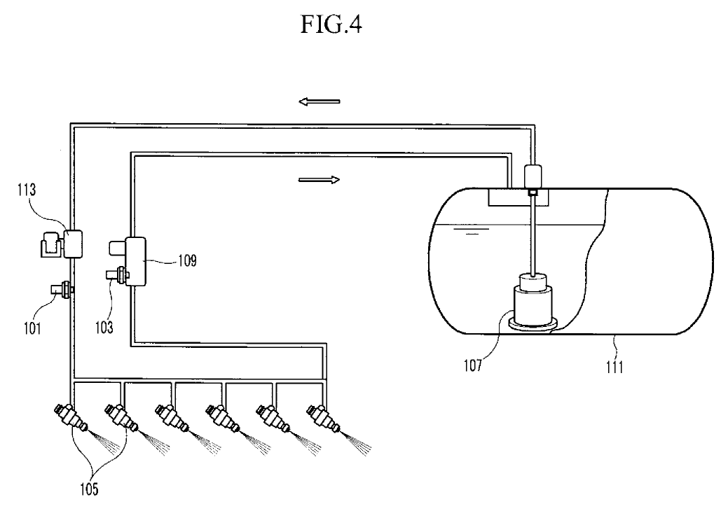

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

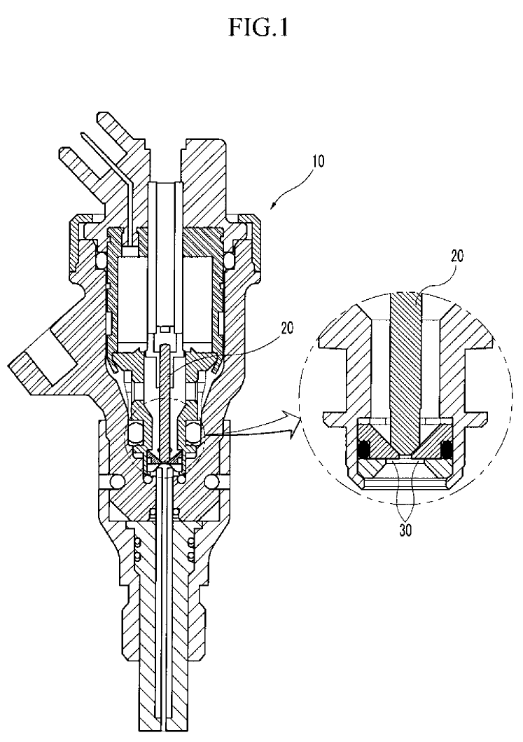

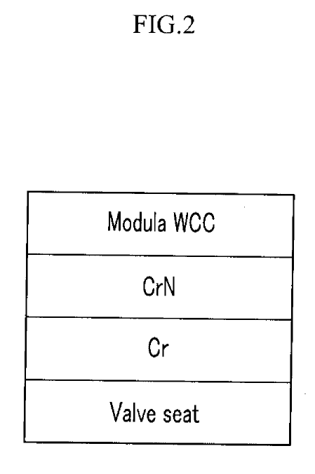

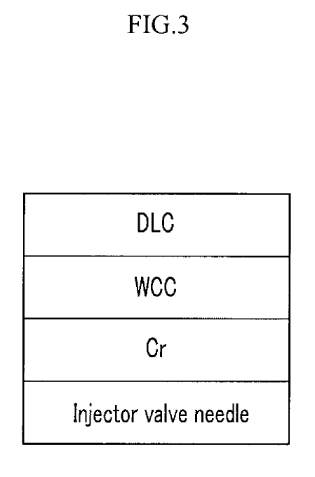

FIG. 1 is a drawing showing a fuel injector according to various embodiments of the present invention, and FIG. 2 and FIG. 3 are drawings of a surface of a valve seat and a surface of an injector valve needle according to various embodiments of the present invention respectively.

Referring to FIG. 1 to FIG. 3, an injector according to various embodiments of the present invention will be explained.

The scheme of an injector 10 according to various embodiments of the present invention is similar to a conventional fuel injector.

That is, an injector 10 according to various embodiments of the present invention includes an injector valve needle 20 and a valve seat 30, which may contact the injector valve needle 20.

The injector valve needle is coated with a diamond-like carbon (DLC) coating and the valve seat is coated with a modula tungsten carbide carbon (modula WCC) coating.

The modula tungsten carbide carbon coating is formed by coating with a tungsten carbide (WC) and a carbon (C), and hardness of the modula tungsten carbide carbon coating may be changed by adjusting a bias voltage when the tungsten carbide carbon is coated. As an example, as more voltage is supplied, more hardness can be obtained. The hardness of the modular WCC layer can be varied by adjusting different bias voltages from a lower layer to an upper layer in the modular WCC. So that various bias voltages is supplied to the modular WCC layer for obtaining various hardness of the modular WCC layer.

In various embodiments of the present invention, when the modula tungsten carbide carbon is coated and the bias voltage is gradually reduced, the hardness can be gradually reduced so that durability against friction can be increased.

Also, anti-corrosion and anti-abrasion characteristics of the valve seat 30 can be enhanced due to the modula coating.

The valve seat 30 may be further coated with a chrome (Cr) coating and a chromium nitride (CrN) coating, and the valve seat may be sequentially coated with the chrome coating, the chromium nitride coating, and the modula tungsten carbide carbon coating from a surface of the valve seat.

The chrome coating may improve the close contacting property, and the chromium nitride coating acts as a supporting layer.

The thickness of the chrome coating may be 0.1-0.5 μm, the thickness of the chromium nitride coating may be 0.2-0.7 μm, and the thickness of the modula tungsten carbide carbon coating may be 1.0-2.0 μm.

The thicknesses can be determined for satisfying anti-corrosion and anti-abrasion characteristics.

It is preferable to coat the above-described coating after the surface of the valve seat 30 is surfaced by ion etching for cleaning the surface.

The injector valve needle 20 may be further coated with a chrome coating and a tungsten carbide carbon (WCC) coating, and the valve needle 20 is sequentially coated with the chrome coating, the tungsten carbide carbon coating, and the diamond-like carbon coating from the surface of the valve needle.

As described above, the chrome coating may improve the close contacting property and the tungsten carbide carbon coating and the diamond-like carbon coating may improve anti-corrosion and anti-abrasion characteristics.

The thickness of the chrome coating is 0.1-0.5 μm, the thickness of the tungsten carbide carbon coating is 0.2-0.7 μm, and the thickness of the diamond-like carbon coating is 1.0-2.0 μm.

The thicknesses can be determined for satisfying anti-corrosion and anti-abrasion characteristics.

It is preferable to coat the above-described coating after the surface of the injector valve needle 20 is surfaced by ion etching for cleaning the surface.

As describe above, the injector 10 according to various embodiments of the present invention has the injector valve needle and the valve seat, which are coated with different coatings, so the anti-abrasion and the anti-corrosion characteristics can be enhanced.

The diamond-like carbon (DLC) and the modular tungsten carbide carbon (modular WCC) can be selectively coated. That is the injector valve needle and the valve seat are coated with different materials each other.

The injector valve needle can be coated with the modular tungsten carbide carbon (modular WCC) and the valve seat can be coated with diamond-like carbon (DLC).

Also, various bias voltages can be supplied to the modular WCC layer from a lower layer to an upper layer of the modular WCC layer when the modular tungsten carbide carbon is coated.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An injector comprising:
an injector valve needle which is coated with a diamond-like carbon (DLC); and
a valve seat that is selectively contacted with the injector valve needle and is coated with a modula tungsten carbide carbon (modula WCC).

2. The injector of claim 1, wherein hardness of the modular tungsten carbide carbon is changed by adjusting a bias voltage when the modular tungsten carbide carbon is coated.

3. The injector of claim 2, wherein the various bias voltages is supplied to the modular WCC layer from a lower layer to an upper layer of the modular WCC layer when the modular tungsten carbide carbon is coated.

4. The injector of claim 1, wherein the injector valve needle is surfaced by ion etching before the injector valve needle starts to be coated.

5. The injector of claim 1, wherein the valve seat is surfaced by ion etching before the valve seat starts to be coated.

6. The injector of claim 1, wherein the valve seat is further coated with a chrome and a chromium nitride (CrN), in sequential order of the chrome, the chromium nitride, and the modula tungsten carbide carbon from a surface of the valve seat.

7. The injector of claim 6, wherein the valve seat is surfaced by ion etching before the valve seat starts to be coated.

8. The injector of claim 6, wherein thickness of the chrome coating is approximately 0.1 μm-approximately 0.5 μm.

9. The injector of claim 6, wherein thickness of the chromium nitride coating is approximately 0.2 μm-approximately 0.7 μm.

10. The injector of claim 6, wherein thickness of the modula tungsten carbide carbon coating is approximately 1.0 μm-approximately 2.0 μm.

11. The injector of claim 1, wherein the injector valve needle is further coated with a chrome and a tungsten carbide carbon in sequential order of the chrome, the tungsten carbide carbon, and the diamond-like carbon from a surface of the valve needle.

12. The injector of claim 11, wherein the injector valve needle is surfaced by ion etching before the injector valve needle starts to be coated.

13. The injector of claim 11, wherein thickness of the chrome coating is approximately 0.1 μm-approximately 0.5 μm.

14. The injector of claim 11, wherein thickness of the tungsten carbide carbon coating is approximately 0.2 μm-approximately 0.7 μm.

15. The injector of claim 11, wherein thickness of the diamond-like carbon coating is approximately 1.0 μm-approximately 2.0 μm.

16. An LPG vehicle comprising the injector of claim 1.

17. An injector comprising:
an injector valve needle; and
a valve seat that is selectively contacted with the injector valve needle,
wherein the injector valve needle and the valve seat are coated with different materials each other.

18. The injector of claim 17, wherein the different materials include at least one of a diamond-like carbon (DLC) and a modula tungsten carbide carbon (modula WCC).

19. The injector of claim 1 8, wherein various bias voltages is supplied to the modular WCC layer from a lower layer to an upper layer of the modular WCC layer when the modular tungsten carbide carbon is coated.
